(19) United States
(12) Patent Application Publication
(10) Pub. No.: US 2014/0212296 A1
(43) Pub. Date: Jul. 31, 2014

(54) METHOD OF COATING OF AND/OR APPLYING LACQUER ON MAGNETIC RINGS OF A ROTOR MAGNETIC BEARING, ROTOR MAGNETIC BEARING, AND VACUUM PUMP

(71) Applicant: Pfeiffer Vacuum GmbH, Asslar (DE)

(72) Inventors: Marco Antonacci, Wetzlar (DE); Herbert Stammler, Griessen (DE)

(73) Assignee: Pfeiffer Vacuum GmbH, Asslar (DE)

(21) Appl. No.: 14/140,705

(22) Filed: Dec. 26, 2013

(30) Foreign Application Priority Data
Jan. 29, 2013 (DE) 102013100853.4

(51) Int. Cl. F04D 19/04; F01D 5/06; H02K 1/22

(52) U.S. Cl. CPC F04D 19/048; H02K 1/22; F01D 5/06
USPC 416/241 R; 310/45; 427/127

(57) ABSTRACT

A method of at least one of coating of and applying lacquer on magnetic rings of a rotor magnetic bearing mounted on the rotor, includes arranging of the magnetic rings (4) of the magnetic bearing on the rotor (1) at a location (3) provided for the magnetic rings (4), and coating of and/or applying lacquer on exposed surfaces (10) of the magnetic rings (4), respectively. The rotor includes magnetic rings arranged thereon or therein and coated or having lacquer applied thereon in accordance with the above-described method, and a vacuum pump includes such a rotor.

### BACKGROUND OF THE INVENTION

1. Field of the Invention

The present invention relates to a method of coating of and/or applying lacquer on magnetic rings of a rotor magnetic bearing with a plurality of magnetic rings arranged on or in the rotor, to a rotor magnetic bearing, and a vacuum pump with the rotor magnetic bearing.

2. Description of the Prior Art

From practice, it is known to protect magnetic rings of a rotor magnetic bearing and a stator magnetic bearing from corrosive process components. Dependent on application, this can be very important, e.g., in order to achieve an adequate corrosion resistance. A simple possibility consists in coating of or applying lacquer to separate parts. The stator magnetic bearing can be easily coated by dipping, sweeping over, or any other suitable method (e.g., chemical vapor deposition (CVD), physical vapor deposition (PVD)), because the stator magnetic bearing, e.g., expands by a limited amount and primarily has outer surfaces.

Contrary to the stator magnetic bearing, the magnetic bearing of a rotor has primarily inner surfaces which can be accessed only with much difficulty and which despite this, should be coated as uniformly as possible in order not to create a too large unbalance in the rotor.

The object of the present invention is to provide a method with which a rotor magnetic bearing having primarily inwardly located surfaces can be coated or lacquered as uniformly as possible. In addition, there should be provided a rotor magnetic bearing that has a uniform coating without air bubbles.

### SUMMARY OF THE INVENTION

According to the invention, the method of coating of and/or applying lacquer to magnetic rings of a magnetic bearing which is arranged on a rotor, is characterized in that the magnetic rings of the magnetic bearing are arranged on the rotor at a location provided for the magnetic rings, and the exposed surfaces of the magnetic rings are subsequently coated.

The novel feature of the invention consists in that the magnetic rings of the magnetic bearing are pushed into a recess usually provided in the rotor for the magnetic rings, and the rings are only subsequently coated or have lacquer applied thereto.

The magnetic material for permanent magnetic bearings, e.g., Samarium-Cobalt (SmCo) or Neodymium-iron-bor (NdFeB) react against mechanical loads, brittle forces, and are sensitive to tension forces. From practice, it is known that a magnetic bearing in a rotor that is equipped with permanent magnetic bearings, advantageously is so formed that the magnetic bearings are so mounted that they are subjected to pressure forces under all operational conditions. This prestress is achieved advantageously by press and/or shrink fit of the magnets in their recess.

From practice, it is known to coat the rings separately and then arrange them in the rotor recess. The magnetic rings are pushed under a very high pressure into a heated rotor so that the rings are firmly set after cooling of the rotor. Thereby, the lacquer of a single layer of the coating rubs off the magnetic rings, and the corrosion resistance of the magnetic rings is not any more provided.

When according to the invention, the magnetic rings are arranged in a recess provided therefor in the rotor before coating, and the coating is carried out thereafter, no lacquer and no coating substance can be rubbed off during mounting.

In addition, the advantage of the inventive method consists in that the lacquer can penetrate into the intermediate spaces between the magnetic rings, whereby the corrosion resistance of the inventive coating is increased.

The filling of the intermediate spaces between the magnetic rings with coating material or lacquer provides for a tight connection of the magnetic rings. This is particular advantageous when the magnetic bearing is mounted on a rotor of a vacuum pump. In this case, no seal gas is needed during the vacuum pump operation. As no seal gas is needed in the region of the rotor-magnetic bearing, e.g., of a vacuum pump, otherwise required valves, channels and a continuous supply of seal gas are eliminated.

In addition, another advantage of the inventive method consists in that no subsequent mechanical treatment is needed. Moreover, conventional magnetic rings can be used, without a need in their modification.

According to a further embodiment of the present invention, the inwardly located, exposed surfaces of the magnetic rings are coated by putting, in a space which is limited by the magnetic rings, a coating substance and/or lacquer, and by rotating the rotor together with the magnetic rings. Thereby, a bubble-free application of the coating substance and/or lacquer becomes possible. In addition, the rotation of the rotor insures a uniform coating so that the rotor unbalance can be reduced to a most possible extent or completely eliminated.

The magnetic rings can already be coated/have lacquer applied thereto or be without lacquer applied thereto/uncoated. In each case by the following application of lacquer/coating according to inventive process, a total and vacuum-tight sealing of the rotor-magnetic bearing is achieved.

There exists a possibility to coat the inwardly located, exposed surfaces by putting a coating substance and/lacquer, and by swinging the rotor together with the magnet rings out. This also permits to achieve a total coating of the magnetic rings of the rotor magnetic bearing. Also, thereby, the intermediate spaces between the magnetic rings are poured out.

It is particular advantageous that after swinging the rotor, together with the magnetic rings, out, excess lacquer can be removed, e.g., diffused. The removal of the excess lacquer should be carried out independent on the method of application of the coating and/or lacquer.

According to a particularly advantageous embodiment of the invention, the coating and/or application of lacquer takes place in vacuum.

A particular advantage of this method consists in that gaps and levels between the magnetic rings are infiltrated by the coating substance or lacquer and, therefore, no virtual leaks and subsequent weak points of the coating can be developed.

If coating or application of lacquer takes place not under vacuum, bubbles can be formed simultaneously or subsequently. If later the rotor is used in a vacuum pump, i.e., under vacuum, the existing gas inclusions can expand and, by forming bubbles, form openings in the coating. The previously enclosed gas can move in the direction of the high vacuum side and cause disturbance in the process. Furthermore, the developing weak point of the coating can cause a non-desirable corrosion of the beneath located material.

According to a further advantageous embodiment of the invention, a coating substance and/or lacquer can be applied with a spraying device. E.g., a spraying gun or a spraying apparatus can be used. Other spraying means also can be envisaged.

There exists a possibility to reciprocate the spraying device once or several times within the magnetic rings to apply several layers of the coating substance or lacquer.

According to a still further advantageous embodiment of the present invention, as a coating material a heat-or UV-hardened plastic material and/or a heat-or UV-hardened lacquer can be used.

According to another advantageous embodiment of the invention, chemical vapor deposition (CVD) or physical vapor deposition (DVD) are used for coating.

According to a yet further advantageous embodiment of the invention, for coating, chemical or galvanic metal depositions, e.g., of nickel are used. Other coating materials and lacquers also can be used.

According to a further, particularly advantageous embodiment of the invention, the rotor, together with the rotor magnetic bearing is mounted in a rotating device. The rotor is rotated and, finally, a coating substance and/or lacquer is brought into space limited by the rotor magnetic rings. The rotation of the rotor permits to achieve a particularly uniform coating during application of lacquer. In addition, it is possible to provide a very thin layer of the coating substance or lacquer with a small thickness.

A still further advantageous embodiment of the present invention contemplates to pre-assembly the rotor magnetic rings in a block, pushing the block in a recess in the rotor, and finally, rotating the rotor and simultaneously or subsequently putting in a coating substance and/or lacquer into a space limited by the rotor magnetic rings.

This method insures a uniform coating with the coating substance or lacquer. Advantageously, the excess material is removed, independent on the type of the coating process, after bringing in the coating substance and/or lacquer. Whether the inner space of the rotor magnetic bearing, e.g., is completely filled with the coating material and/or lacquer, or only portion of this space is filled with the coating material and/or lacquer, and the space, together with the magnetic rings, is swung out, it is necessary to subsequently remove the excess material.

According to the invention, it is advantageous when the lacquer and/or coating material cover the inwardly located surfaces of the magnetic rings and/or are provided in the intermediate spaces. Thereby, a vacuum-tight lacquer layer or coating is obtained.

It is possible to apply several layers. It is also possible to deposit several layers of different materials.

Advantageously, a rotor with several magnetic rings which are coated and/or have lacquer applied thereto by the inventive process and which are arranged in or on the rotor, is so produced that the magnetic rings are pushed into the provided therefor recess in the rotor before being coated, without rubbing-off of the lacquer already covering the ring. It is possible to mount each ring separately or pre-assembly the rings into a block and then push the entire block into the recess provided therefor. The rings or the block are mounted in the recess only under high pressure. However, usually, the rotor is heated so that it expands, and the rings or the block are pushed therein. When the rotor cools, the rings are firmly set in or on the rotor. Finally, the rings are coated or have the lacquer applied thereto by the inventive process. Thereby, a uniform and intact deposition of the coating substance and/or lacquer is possible. In addition the material penetrates in the intermediate spaces and levels of the magnetic rings, so that the lacquer and/or the coating substance is not damaged during mounting of the rotor.

According to a yet another advantageous embodiment of the invention, the rotor, together with the inventive magnetic bearing, is mounted in a vacuum pump. Vacuum pumps having a rapidly rotating rotor, should not have any unbalance. On the other hand, it is important to form the rotor-magnetic bearing assembly tightly and without any inclusions. The inclusions damage the coating or the lacquer upon application of vacuum.

Because the rotor-magnetic bearing assembly is formed vacuum-tightly, the seal gas and the necessary for the seal gas valves and channels, and a continuous supply of the seal gas all can be dispensed with.

According to a particularly advantageous embodiment of the invention, the rotor is formed as a rotor of a turbomolecular pump. With this type of a pump with rapidly rotatable rotor, the use of the inventive rotor-magnetic bearing assembly is particularly advantageous.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a longitudinal cross-sectional view of a rotor with a magnetic bearing and located in a vacuum chamber during a coating process; and

FIG. 2 a section of the rotor, which is defined by a circle in FIG. 1, at an increased scale.

### DETAILED DESCRIPTION OF THE PREFERRED EMBODIMENTS

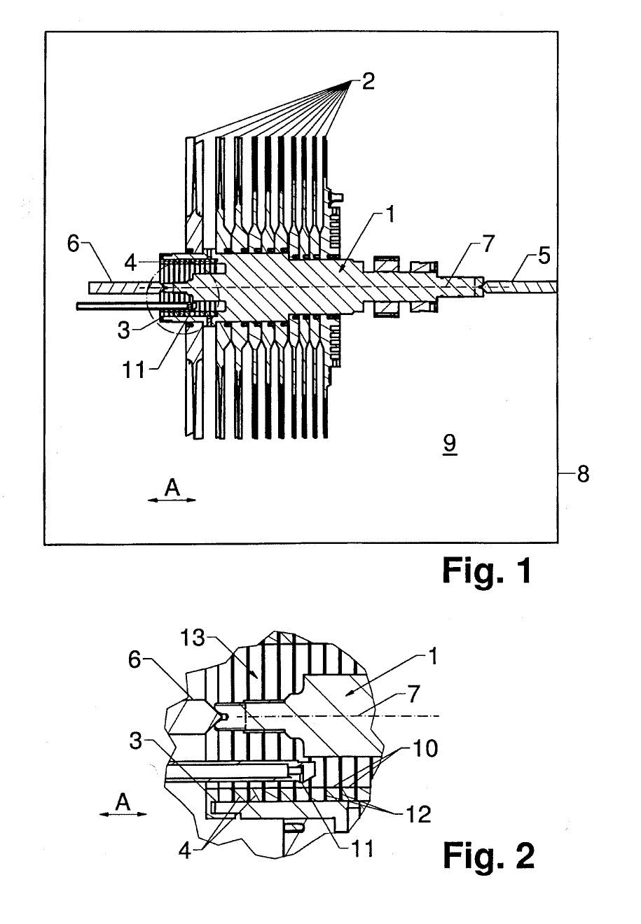

FIGS. 1-2 show a rotor 1 carrying rotor discs 2. In a recess 3, a plurality of magnetic rings 4 of a rotor magnetic bearing are arranged. The rotor 1 is located between two pointed axles 5 and 6 which provide for rotation of the rotor 1 about its longitudinal axis 7. The rotor 1 is located in a vacuum chamber 8. In the interior 9 of the vacuum chamber 8 vacuum is provided.

For coating of the exposed inner surfaces 10 of the magnetic rings 4, a spraying head 11 is provided in the vicinity of surfaces 10. The spraying head 11 reciprocates once or multiple times in the direction of a double arrow A during rotation of the rotor 1 and, thereby, of the magnetic ring 4 about the longitudinal axis 7 of the rotor 1.

By spraying lacquer or a coating substance with the spraying head 11, the surfaces 10 are coated, and intermediate spaces 12 between the magnetic rings 4 are filled with lacquer and/or the coating substance.

In this way, a thin and uniform coating is provided on the surfaces 10. By effecting coating in the vacuum chamber 8 under vacuum, leaks and a subsequent formation of bubbles between the magnetic rings 4 are excluded.

The pointed axles 5, 6 are shown only schematically. Obviously, retaining and rotating devices are provided for the pointed axles 5, 6. The vacuum chamber 8 is also shown schematically. The vacuum chamber 8 is connected with at least one vacuum pump (not shown).

After coating or application of lacquer in the magnetic rings 4, the rotor 1 is removed from the vacuum chamber 8. The pointed axles 5, 6 are withdrawn, and the rotor 1, together with the magnetic bearing formed of magnetic rings 4, is mounted in a vacuum pump (not shown). A magnetic bearing stator is associated with the rotor magnetic bearing with the magnetic rings 4.

Instead of using the spraying head 11, a spraying gun, a coating substance can fill the inner space 13 limited by the magnetic ring 4. The space 14 with the coating substance swings out, and it is finally removed. In this case, the pointed axles 5, 6 are not necessary. For swinging the coating substance out, a corresponding retaining and pivoting device (not shown) is provided in the vacuum chamber 8.

Though the present invention was shown and described with references to the preferred embodiments, such are merely illustrative of the present invention and is not to be construed as a limitation thereof and various modifications of the present invention will be apparent to those skilled in the art. It is, therefore, not intended that the present invention be limited to the disclosed embodiments or details thereof, and the present invention includes all variations and/or alternative embodiments within the spirit and scope of the present invention as defined by the appended claims.

What is claimed is:

1. A method of at least one of coating of and applying lacquer to magnetic rings of a rotor magnetic bearing mounted on the rotor, the method comprising the steps of arranging of the magnetic rings (4) of the magnetic bearing on the rotor (1) at a location (3) provided for the magnetic rings (4); and at least one of coating of and applying lacquer to exposed surfaces (10) of the magnetic rings (4), respectively.

2. A method according to claim 1, wherein the step of at least one of coating and applying lacquer includes coating of the inwardly located, exposed surfaces (10) by putting in at least one of a coating substance and lacquer, respectively, and by rotating the rotor together with the magnetic rings (4).

3. A method according to claim 1, wherein the step of at least one of coating and applying lacquer includes coating of the inwardly located, exposed surfaces (10) by putting in at least one of a coating substance and lacquer, respectively, and by swinging the rotor together with the magnetic rings (4) out.

4. A method according to claim 1, wherein the step of at least one of coating and applying lacquer includes coating and applying lacquer under vacuum.

5. A method according to claim 2, wherein the step of putting in of at least one of coating substance and lacquer includes spraying of the at least one of the coating substance and lacquer.

6. A method according to claim 1, wherein the spraying step includes use of a spraying device (11).

7. A method according to claim 6, wherein the spraying step includes the spraying device (11) reciprocates once or multiple times within the rotor magnetic rings (4) during a spraying process.

8. A method according to claim 1, wherein the step of at least one of coating and applying lacquer includes at least one of coating with a plastic material of and applying an UV-hardened lacquer on, respectively, the rotor magnetic rings.

9. A method according to claim 2, wherein the step of at least one of coating and applying lacquer includes arranging the rotor (1) in a rotating device (5, 6) rotating the rotor, and, finally, putting in the at least one of coating substance and lacquer in a space (13) limited by the rotor magnetic rings (4).

10. A method according to claim 1, wherein the arranging step includes pre-assembly the rotor magnetic rings (4) in a block, arranging the block in a recess (3) formed in the rotor (1), and the step of at least one of coating and applying lacquer includes subsequently rotating the rotor (1) and at least one of simultaneously and subsequently putting in at least one of a coating substance and lacquer, respectively, in a space (13) limited by the rotor magnetic rings.

11. A method according to claim 1, further comprising the step of removing excess material from the space limited by the rotor magnetic rings.

12. A method according to claim 1, wherein the step of the at least one of coating and applying lacquer includes providing a coating substance and lacquer, respectively, at least one on inwardly located exposed surfaces (10) of the magnetic rings (4) and in intermediate spaces (12) between the magnetic rings.

13. A rotor, comprising a plurality of magnetic rings arranged one of on the rotor and in the rotor, wherein the magnetic rings are one of coated and having lacquer applied thereon by a method including arranging of the magnetic rings (4) on the rotor (1) at a location (3) provided for the magnetic rings (4) and coating of and applying lacquer on exposed surfaces (10) of the magnetic rings (4), respectively, and wherein the magnetic rings (4) are arranged one of on the rotor and in the rotor before being coating and having lacquer applied thereon, respectively.

14. A rotor according to claim 13, wherein the rotor is formed as a vacuum pump rotor.

15. A rotor according to claim 14, wherein the rotor is formed as a turbomolecular pump rotor.

16. A vacuum pump, comprising a rotor having a plurality of magnetic rings arranged one of on the rotor and in the rotor, wherein the magnetic rings are one of coated and having lacquer applied thereon by a method including arranging of the magnetic rings (4) on the rotor (1) at a location (3) provided for the magnetic rings (4), and coating of and applying lacquer on exposed surfaces (10) of the magnetic rings (4), respectively, and wherein the magnetic rings (4) are arranged one of on the rotor and in the rotor before being coated and having lacquer applied thereon, respectively.
